(19) United States
(12) Patent Application Publication
(10) Pub. No.: US 2002/0132610 A1
(43) Pub. Date: Sep. 19, 2002

(54) Profile-dependent background picture for mobile terminal displays

(76) Inventors: Catriona Chaplin, Lund (SE); Per Ogren, Helsingborg (SE)

Correspondence Address: Richard J. Moura, Jenkens & Gilchrist, P.C., 3200 Fountain Place, 1445 Ross Avenue, Dallas, TX, 75202-2799, US

(21) Appl. No.: 09/761,629

(22) Filed: Jan. 17, 2001

(51) Int. Cl. H04M 3/42

(52) U.S. Cl. 455/414; 455/432

(57) ABSTRACT

Method and apparatus for indicating the currently selected profile in a mobile terminal are disclosed. A background picture is selectively associated with each profile and stored in the mobile terminal. When a profile is selected, the background picture for that profile is retrieved and displayed on the display screen of the mobile terminal. The profile may be selected either manually by the user, or automatically when the mobile terminal is engaged with certain accessories. Default background pictures may be replaced with alternative background pictures obtained from external sources.

### BACKGROUND

1. Technical Field of the Invention

The present invention is related generally to mobile communication terminals and, in particular, to a method and apparatus for displaying a background picture in a mobile terminal.

2. History of the Related Art

Mobile terminals such as cell phones, pagers, personal digital assistants (PDA), and the like have a number of convenient services and features to help make them easier to use. These services and features include ring volume control, vibrating alert, call diversion, hands-free calling, and a number of other similar enhancements. The services and features are commonly packaged as part of a preset calling plan, or they may be provided as options to be purchased separately.

In a typical mobile terminal, a user may manually configure and activate each service and feature individually, or several services and features may be configured and activated together as a group in a “profile.” A profile is essentially a group of services and features that have been preset in order to suit a certain usage environment. The profiles may be created and modified as needed by the user, or one of several default profiles may be used. The preset services and features become activated when their profile is selected. For example, during a business meeting environment, a user may select a “Meeting” profile to silence or otherwise reduce the volume of the ringer and activate the vibrating alert so as to minimize any disturbance that may be caused by an incoming call. Selection of a profile may be accomplished by manipulation of various input keys and buttons to arrive at the appropriate menu option.

A profile may also be selected automatically in some mobile terminals when certain accessories are engaged. An accessory is basically an auxiliary equipment that provides the user access to a number of useful features and services in addition to those already provided with the mobile terminal. These accessories may include car adapters, battery chargers, modem interfaces, and the like. For example, an “In Car” profile may be automatically selected when the mobile terminal is plugged into a car adapter. When the mobile terminal is removed from an accessory where profile selection was automatic, the mobile terminal reverts to the previously selected profile.

TABLE 1

| | Normal | Meeting | In Car | Home |
|---|---|---|---|---|
| Ring Vol | 5 (6) | 2 (6) | 6 (6) | 5 (6) |
| Increase Ring | Off | Off | Off | Off |
| Vibrate Alert | On if | On if | Off | On |
| | Silent | Silent | | |
| Accept Calls | From All | From All | From All | From All |
| Divert Calls | Off | Off | Off | Off |
| Calling Card | None | None | None | None |
| Light | Auto | Auto | Auto | Auto |
| Line ½ | L1 | L1 | L1 | L1 |
| Silent | Off | On | Off | Off |
| Auto Activate | Off | Off | On | Off |
| Accessory | — | — | Car Hands | — |
| | | | Free | |

TABLE 1 shows a number of exemplary profiles and the features that may be preset for each profile. Looking at the “Meeting” profile, for example, it can be seen that the ring volume has been set to level 2 out of 6, the increasing ring feature is off, the vibrating alert will come on if the mobile terminal is in the silent mode, all calls are accepted, no accepted calls are diverted, no calling card is available for the user, the display screen light comes on automatically, line one of two is selected, the silent ringing mode is on, automatic profile activation is off, and no accessory is associated with this profile. Note that the names of the profiles and the features and settings associated therewith as shown in TABLE 1 are the typical default values and may be changed by the user as needed.

The particular profile currently selected is usually indicated in text on the display of the mobile terminal. FIG. 1 shows an exemplary mobile terminal 10 having a body or housing 12 and input keys 14. The input keys 14 allow a user to operate the mobile terminal 10 including placing and receiving calls and to navigate the various menu options available. A number of status indicators (e.g., signal strength, time, battery power, etc.), shown collectively at 16, and a text based profile indicator 18 are displayed on a display screen 20. Such a visual arrangement lets a user easily determine various information about the mobile terminal including the particular profile currently selected.

The trend in mobile terminal design, however, is to move toward a graphics oriented display screen 20 in order to make the mobile terminal more user-friendly. As such, in future mobile terminals, it is expected that a large part of the display screen 20 will be filled with a background picture. This design change, however, will reduce the already limited space available on the display screen 20. Thus, in future mobile terminals, there may not be enough display space for displaying the text based profile indicator 18.

One method of alleviating the lack of available space on the display screen 20 is to replace the text based profile indicator 18 with a small icon. However, such an icon would not only be difficult to see, but would require the user to correctly remember and interpret the icon for each profile in addition to all the other information being displayed.

Therefore, it is desirable to be able to provide a way to clearly indicate which profile is currently selected on a mobile terminal having limited space on the display screen.

### SUMMARY OF THE INVENTION

The present invention is directed to a method and apparatus for indicating the currently selected profile in a mobile terminal. A background picture is selectively associated with each profile and stored in the mobile terminal. When a profile is selected, the background picture for that profile is retrieved and displayed on the display screen of the mobile terminal. The profile may be selected either manually by the user, or automatically when the mobile terminal is engaged with certain accessories. Default background pictures may be replaced with alternative background pictures obtained from external sources.

In general, in one aspect, the invention is directed to a method of indicating a selected profile in a mobile terminal having a plurality of profiles. The method comprises the steps of associating a background picture with at least one of the plurality of profiles in the mobile terminal, retrieving the background picture from a storage location in the mobile terminal when one of the plurality of profiles is selected, and displaying the retrieved background picture on a display screen of the mobile terminal.

In general, in another aspect, the invention is directed to a mobile terminal having a plurality of profiles therein. The mobile terminal comprises a memory unit configured to store a background picture associated with at least one of the plurality of profiles, a controller configured to retrieve the background picture from the memory unit when one of the plurality of profiles is selected, and a display unit for displaying the retrieved background picture on a display screen of the mobile terminal.

In general, in yet another aspect, the invention is directed to a mobile terminal having a plurality of selectable services and features, the selectable services and features being predefined in one or more profiles. The mobile terminal comprises a memory unit configured to store a background picture associated with at least one of the one or more profiles, the background picture including a graphical image, textual information, and a colored setting, wherein the background picture is indicative of a selected one of at least the following usage profiles: Normal, Meeting, In Car, and Home. A controller is configured to retrieve the background picture from the memory unit when one of the one or more profiles is selected, either manually, or automatically when the mobile terminal is engaged with a predetermined accessory. A display unit displays the retrieved background picture on a display screen of the mobile terminal.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

A more complete understanding of the method and apparatus of the present invention may be had by referenced to the Detailed Description and the following Drawings, wherein:

FIG. 1 illustrates a typical prior art mobile terminal;

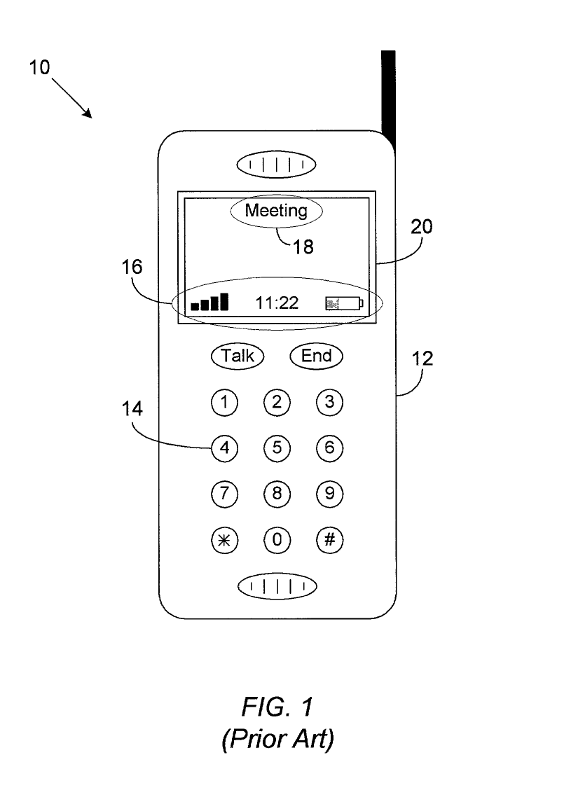

FIGS. 2A-2D illustrate exemplary display screens according to one embodiment of the present invention;

FIG. 3 is a functional block diagram of a mobile terminal according to one embodiment of the present invention; and

FIG. 4 is a flow chart of a method according to one embodiment of the present invention.

### DETAILED DESCRIPTION OF EXEMPLARY PREFERRED EMBODIMENTS

Following is a detailed description of the exemplary preferred embodiments of the present invention with reference to the Drawings, wherein like numerals refer to like and corresponding parts.

As alluded to earlier, in future mobile terminals, it is expected that a large part of the display screen will be filled with a background picture, leaving little available space for displaying a profile indicator. The present invention alleviates the lack of available display space by using the background picture itself to indicate the currently selected profile. Preferably, a different background picture is used for each one of a plurality of profiles, although it is certainly possible to use the same background picture for two or more profiles. The background pictures may be preset as the default selection for various profiles by the manufacturer or distributor of the mobile terminal and subsequently changed by the user. Alternative background pictures may be obtained by the user from one or more different sources. When a user selects a new profile, the background picture for the newly selected profile is retrieved from a storage location in the mobile terminal and displayed on the display screen. A new profile may also be automatically selected by the mobile terminal upon engagement thereof to certain accessories.

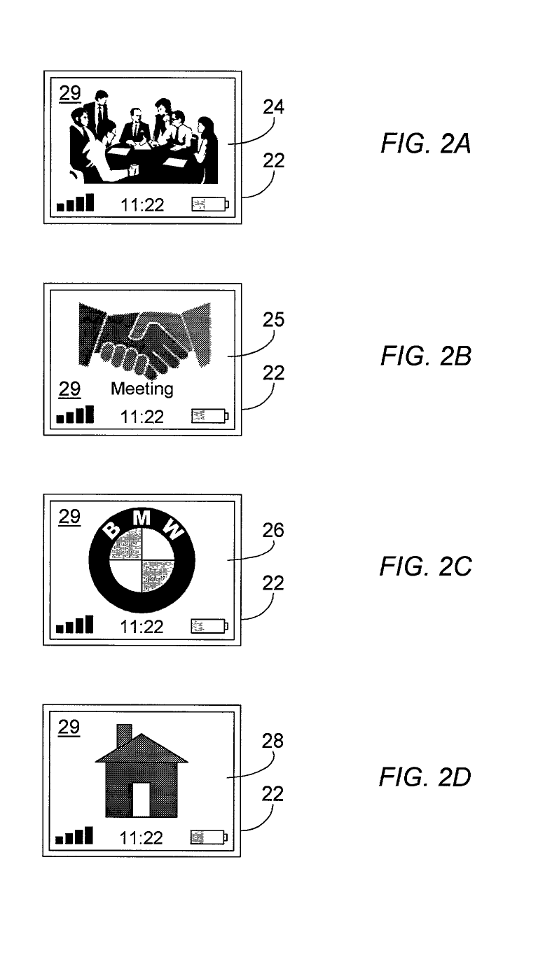

Referring now to FIGS. 2A-2D, display screens 22 according to one embodiment of the present invention are shown. As can be seen, several exemplary background pictures indicative of various profiles are displayed on the display screens 22. In general, any background picture may be displayed with any profile, but preferably the background picture associated with a given profile is one that is indicative of the nature and character of the profile. For example, in FIG. 2A, a background picture 24 of a group of people having a meeting is used to indicate the “Meeting” profile. Thus, when the user sees the meeting background picture 24 displayed on the display screen 22, he or she will naturally conclude that the “Meeting” profile is the one currently selected. Under such an arrangement, there is no need for a separate profile indicator to indicate the currently selected profile, thereby freeing up valuable space on the display screen 22 for other purposes.

The background picture can include not only graphical images, but also textual information together with the images. For example, the “Meeting” profile may be indicated by the background picture 25 of a handshake with the text “meeting” either underneath as shown in FIG. 2B, or directly over the background picture 25, or in some other convenient location. Such a background picture can make it even more clear to the user which one of the plurality of profiles is currently selected.

FIG. 2C illustrates the case where the “In Car” profile is the one currently selected. As can be seen, the background picture 26 is the logo for BMW (TM), which is presumably, although not necessarily, the manufacturer of the user's automobile. When seeing such a logo displayed as a background picture 26 on the display screen 22, the user will naturally recognize that the mobile terminal is in the “In Car” profile.

As mentioned previously, the “In Car” profile is one that can be selected automatically by the mobile terminal. For example, when the user inserts the mobile terminal into an automobile type accessory such as a car adapter (not shown), the mobile terminal detects that it has been thus inserted, and automatically switches itself to the appropriate profile. The background picture 26 for the new profile, which is the BMW logo in this case, will thereafter be displayed on the display screen 22. In a preferred embodiment, if the mobile terminal is disconnected from the accessory, it will automatically switch itself to the previously selected profile. The background picture for that previous profile will thereafter be displayed on the display screen 22.

FIG. 2D illustrates the case where the mobile terminal is in the “Home” profile, as indicated by background picture 28 of a house. This profile is typically selected manually by the user when he or she has arrived home. Later, upon seeing the house background picture 28 displayed on the display screen 22, the user will naturally realize that the mobile terminal is in the “Home” profile. In some embodiments, the “Home” profile may be configured so as to be automatically instead of manually selected by the mobile terminal upon insertion into a home type accessory such as a battery charger (not shown). In that case, no manual selection is necessary, and the house background picture 28 will be displayed automatically on the display screen 22.

It should be noted that, although the images in the background pictures 24-28 are shown in a setting 29 that is clear or white in FIGS. 2A-2D, the invention is not to be limited thereto. For mobile terminals with color display capability, each of the background pictures 24-28 may have a setting 29 that is a different color in order to further distinguish the particular profile selected. Indeed, in some embodiments, the background picture itself may simply be a setting 29 of one or more colors (i.e., no images), with different colors or combinations of colors representing different profiles.

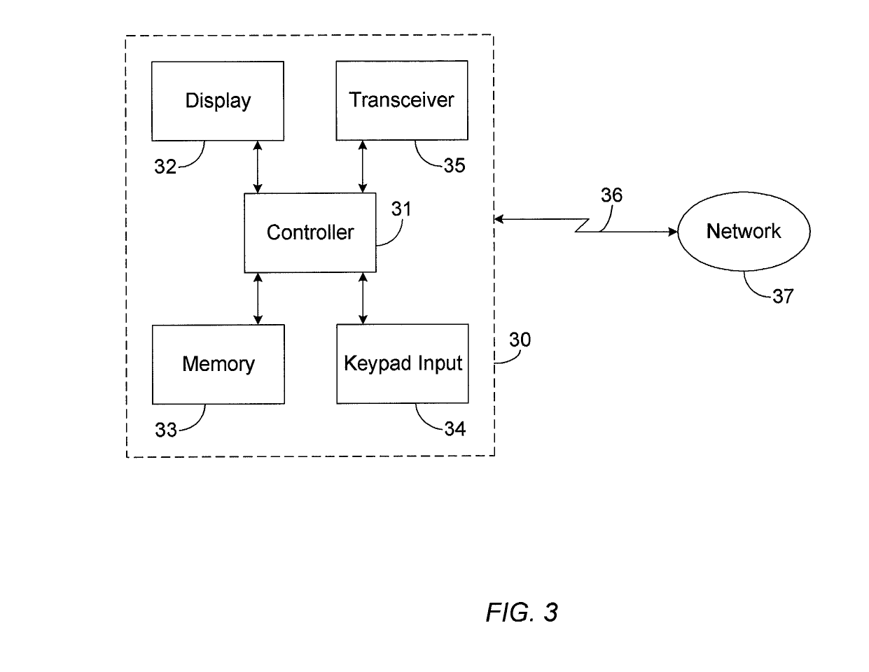

Referring now to FIG. 3, an exemplary mobile terminal 30 according to one embodiment of the present invention is shown. The mobile terminal 30 has a number of functional components including a controller 31, a display unit 32, a memory unit 33, a keypad input unit 34, and a transceiver unit 35. A radio interface 36 links the mobile terminal 30 to a network 37. Following is a more detailed description of the various functional components of the mobile terminal 30. Those of ordinary skill in the art will recognize that these functional components may be implemented in the mobile terminal 30 as either software, hardware, or a combination of both software and hardware.

The controller 31 is generally responsible for the overall operation of the mobile terminal 30 including the execution of various software programs thereon such as the mobile terminal operating system and other control software. In one embodiment, the controller 31 also controls the display of the background picture on the display unit 32. For example, upon detecting or otherwise becoming aware that a new profile has been selected in the mobile terminal, either manually or automatically, the controller 31 executes the appropriate instructions to cause the particular background picture 22 associated with the selected profile to be retrieved from the memory unit 33 and thereafter displayed on the display unit 32.

The display unit 32 is generally responsible for displaying all images and text in the mobile terminal 30 including any background picture under the control of the controller 31. Examples of the display unit 32 may include a color or a monochrome liquid crystal display panel or other similar types of displays along with their associated control circuitry.

The memory unit 33 provides storage for any software programs and data that may be required by the controller 31 for operating the mobile terminal 30. In particular, the memory unit 33 provides storage for the background pictures that are displayed in connection with the various profiles in the mobile terminal 30. Examples of the memory unit 33 may include a random access memory, read-only memory, flash memory, or some combination thereof. In some embodiments, the memory unit 33 may also include a removable media such as a memory card or a SIM (Subscriber Identity Module) that stores personal user information. Preferably, the storage capacity of the memory unit 33 is sufficient to store at least one different background picture for each profile in the mobile terminal 30.

The keypad unit 34 may include a number of keys (not shown) and associated circuitry, and is responsible for receiving and translating the input from the user into electrical signals that can be processed by the controller 31. In this regard, the keypad unit 34 is more or less the same as other keypad units commonly known to those of ordinary skill in the art and further description thereof is not needed herein.

The transceiver unit 35 is responsible for the actual sending and receiving of signals to and from the mobile terminal 30 under the control of the controller 31. Thus, the transceiver unit 35 includes all necessary hardware and/or software components for performing such tasks as adjusting the strength of the transmitted signal, frequency conversion, modulation/demodulation, encoding/decoding, encryption/ decryption where applicable, and other related tasks.

The radio interface 36 may be any type of link that can connect the mobile terminal 30 to the network 37. For example, where the network 37 is mobile communications system such as the Global System for Mobile Communication (GSM), the radio interface 36 may be a cellular link. The radio interface 36 may also be a direct wireless link where the network 37 is a local ad hoc network such as a Bluetooth (TM) network. In the case of the Bluetooth (TM) network, two or more mobile terminals 30 (or other Bluetooth (TM) equipped devices) may be connected directly to each other over a single wireless link to form the network 37. The network 37 may also be the Internet, in which case the radio interface 36 may include all necessary links to facilitate a wireless Internet connection from the mobile terminal 30.

Once the mobile terminal 30 is connected to the network 37, the user has access to a wealth of activity choices and options. For example, as mentioned earlier, the mobile terminal 30 is initially configured with a number of default background pictures. If the user wishes to customize the mobile terminal 30, he or she may do so by obtaining an alternative background picture via the network 37. For example, the user may download background pictures from an appropriate Web site on the Internet. The user may also receive and/or send the background pictures from and/or to other users via an email attachment. Thereafter, the newly obtained picture may be retrieved and displayed when the particular profile is selected.

Of course, the network 37 is just one of many available sources of background pictures, and other sources of background pictures may certainly be used without departing from the scope of the invention. For example, the user may obtain background pictures from a personal computer, or from another mobile terminal through a direct connection (not shown) thereto. Such direct connections may include an infrared link, the Bluetooth (TM) wireless link mentioned above, a serial cable, or other similar connection methods.

In some embodiments, the above newly obtained background picture may replace the default background picture in the memory unit 33 for a given profile. However, in other embodiments, depending on the amount of storage space available, both the new and default background pictures may be stored in the memory unit 33, and only the association thereof to a given profile is changed.

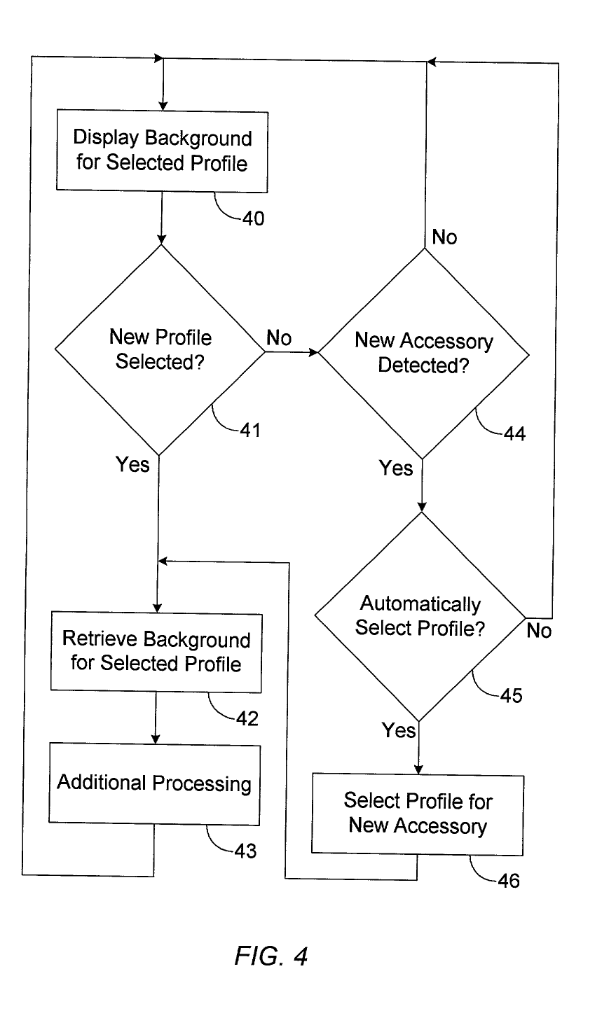

Referring now to FIG. 4, a method according on embodiment of the invention is shown. At step 40, the background picture for the selected profile is displayed on the display unit of the mobile terminal. Next, a determination is made by the controller as to whether a new profile has been selected at step 41. If yes, the background picture for the newly selected profile is retrieved from a storage location in the mobile terminal at step 42. At step 43, additional processing is performed as needed by the controller (e.g., formatting the background picture, adjusting the display screen, etc.), and the background picture is displayed at step 40.

If no, a determination is made by the controller as to whether the mobile terminal has been plugged into a new accessory at step 44. If no, then the controller maintains the background picture for the currently selected profile at step 40. If yes, then another determination is made by the controller at step 45 as to whether the new accessory is one that will trigger automatic selection of a new profile. If yes, then a profile is automatically selected by the controller for that accessory at step 46. The method then continues at step 42 where the background picture for the newly selected profile is retrieved from the storage location in the mobile terminal, and so on. If no, then the controller maintains the background picture for the currently selected profile at step 40.

Although various preferred embodiments of the invention have been shown and described, it will be appreciated by those skilled in the art that changes may be made to these embodiments without departing from the principles and the spirit of the invention, the scope of which is defined in the appended claims.

What is claimed is:

1. A method of indicating a selected profile in a mobile terminal having a plurality of profiles, comprising the steps of:
associating a background picture with at least one of the plurality of profiles of said mobile terminal;
retrieving said background picture from a storage location in said mobile terminal when one of the plurality of profiles is selected; and
displaying said retrieved background picture on a display screen of said mobile terminal.

2. The method according to claim 1, further comprising obtaining said background picture via a network.

3. The method according to claim 2, wherein said network includes the Internet.

4. The method according to claim 2, wherein said network includes an ad hoc network.

5. The method according to claim 2, wherein said network includes a mobile communications system.

6. The method according to claim 1, further comprising obtaining said background picture via an email attachment.

7. The method according to claim 1, further comprising obtaining said background picture via a direct connection with another mobile terminal.

8. The method according to claim 7, wherein the direct connection includes a Bluetooth (TM) wireless link.

9. The method according to claim 7, wherein the direct connection includes a infrared link.

10. The method according to claim 1, further comprising manually selecting said at least one of said plurality of profiles.

11. The method according to claim 1, further comprising automatically selecting said at least one of said plurality of profiles when said mobile terminal is engaged with a predetermined accessory.

12. The method according to claim 10, further comprising displaying a background picture associated with a previously selected profile when said mobile terminal is disengaged from said predetermined accessory.

13. The method according to claim 1, wherein said background picture includes a graphical image.

14. The method according to claim 1, wherein said background picture includes textual information.

15. The method according to claim 1, wherein said background picture includes a colored setting.

16. The method according to claim 1, wherein said background picture is indicative of a selected one of at least the following profile types: Normal, Meeting, In Car, and Home.

17. A mobile terminal having a plurality of profiles therein, comprising:
a memory unit configured to store a background picture associated with at least one of said plurality of profiles;
a controller configured to retrieve said background picture from said memory unit when one of said plurality of profiles is selected; and
a display unit for displaying said retrieved background picture on a display screen of said mobile terminal.

18. The mobile terminal according to claim 17, wherein said background picture may be obtained via a network.

19. The mobile terminal according to claim 17, wherein said network includes the Internet.

20. The mobile terminal according to claim 17, wherein said network includes an ad hoc network.

21. The mobile terminal according to claim 17, wherein said network includes a mobile communications system.

22. The mobile terminal according to claim 17, further comprising obtaining said background picture via file transfer over a direct connection with another mobile terminal.

23. The mobile terminal according to claim 22, wherein the direct connection includes a Bluetooth (TM) wireless link.

24. The mobile terminal according to claim 22, wherein the direct connection includes a infrared link.

25. The mobile terminal according to claim 17, further comprising obtaining said background picture via an email attachment.

26. The mobile terminal according to claim 17, wherein said at least one of said plurality of profiles may be manually selected.

27. The mobile terminal according to claim 17, wherein said at least one of said plurality of profiles may be automatically selected when said mobile terminal is engaged with a predetermined accessory.

28. The mobile terminal according to claim 27, wherein said controller causes said display unit to display a background picture associated with a previously selected profile when said mobile terminal is disengaged from said predetermined accessory.

29. The mobile terminal according to claim 17, wherein said background picture includes a graphical image.

30. The mobile terminal according to claim 17, wherein said background picture includes textual information.

31. The mobile terminal according to claim 17, wherein said background picture includes a colored setting.

32. The mobile terminal according to claim 17, wherein said background picture is indicative of a selected one of at least the following profile types: Normal, Meeting, In Car, and Home.

33. A mobile terminal having a plurality of selectable services and features, said selectable services and features being predefined in one or more profiles, comprising:
a memory unit configured to store a background picture associated with at least one of said one or more profiles, said background picture including a graphical image, textual information and a colored setting, wherein said background picture is indicative of a selected one of at least the following profile types: Normal, Meeting, In Car, and Home;
a controller configured to retrieve said background picture from said memory unit when one of said one or more profile is selected, either manually, or automatically when said mobile terminal is engaged with a predetermined accessory; and
a display unit for displaying said retrieved background picture on a display screen of said mobile terminal.
